(19) United States
(12) Patent Application Publication
(10) Pub. No.: US 2017/0080567 A1
(43) Pub. Date: Mar. 23, 2017

(54) SYSTEM, ESPECIALLY FOR PRODUCTION, UTILIZING COOPERATING ROBOTS

(71) Applicant: INSTITUT DE RECHERCHE TECHNOLOGIQUE JULES VERNE, Bouguenais (FR)

(72) Inventors: ANDRÉ QUINQUIS, MILIZAC (FR); DAVID MARQUEZ-GAMEZ, REZE (FR); ALEXIS GIRIN, TREILLIERES (FR)

(21) Appl. No.: 15/106,819

(22) PCT Filed: Dec. 23, 2014
(86) PCT No.: PCT/EP2014/079280

§ 371 Date: Nov. 29, 2016

(30) Foreign Application Priority Data
Dec. 23, 2013 (FR) 1363422

(51) Int. Cl. B25J 9/16; G05D 1/02; G05D 1/00

(52) U.S. Cl. CPC B25J 9/1682; G05D 1/0088; G05D 1/0202; B25J 9/1694; G05D 1/021; G05D 1/0274; G05D 1/0276; Y10S 901/01

(57) ABSTRACT

A robot, specifically a cobot, with a mobile base includes a memory, sensors, a communications device, a processor, and a codrone. An unvarying map of the space in which the cobot is likely to move is saved in the memory. The sensors on board the cobot are configured to inform the cobot about its concentric environment. Information are issued and received via the communications device. The processor process the information received from the sensors and the communication device. The codrone, separate from the cobot, is used to explore the environment. The codrone is configured to move in the space on its own and communicates information to the cobot via the communication device. A robotic system having a plurality of cobots and a method for updating working maps of the cobots of the robotic system are also disclosed.

This invention relates to a system, particularly a production system, using cooperating robots. The invention is more specifically but not exclusively adapted to a flexible production system, particularly in the areas of automobiles, aeronautics, shipbuilding and energy production, where several robots operate at the same time as human workers for the assembly and handling of changing assemblies or subassemblies that make it necessary to reconfigure the production system between assemblies.

A robot suitable for cooperating with a robotic or human operator is commonly called a ‘cobot’. That term encompasses both manipulators known as haptic manipulators, meaning that their movements are directly controlled by the movements of a person, which make it possible to increase the manipulating power of the operator, for example, for manipulating heavy or large parts, or on the contrary, to carry out very minute tasks, particularly but not exclusively on the microscopic scale, or in a particular environment such as for surgical operations, and independent robots that work in environments in which human or robotic operators also work, and which are likely to interact with those operators for the performance of the work. As part of an automated production system, several cobots of two types are likely to work along with human operators or in the close vicinity of said human operators.

In the prior art, the work of a human operator in the vicinity of a robot is a complex situation in view of the hazards represented by the moving robot, which is programmed to carry out specific tasks but which must also keep any operator entering its working area safe. The problem is similar for coordinating several robots with working areas that share volumes, in order to avoid collisions. The problem of the reprogramming of a robot in a modified working area is a difficult one. Document U.S. Pat. No. 7,298,385 provides an example of the difficulty. The automatic application of the change in environment firstly faces an issue of computational power and secondly that of the ability to perceive and survey the environment.

Thus, cobots must be fitted with sensors that can survey their environment and be programmed so as to be able to make decisions about possible action depending on the environment. In the prior art, the environment is surveyed, firstly, from a map of the place of work saved in the programming means of the robot, secondly by location means such as markers, which enable the robot to know its position on said map, and thirdly by sensors fitted on the robot itself, which provide it with a concentric image of its environment.

The working volume perceived by the robot in which the robot is capable of moving safely, regarding both itself and other operators, human or robotic, is called the ‘volume of perception’. Said volume of perception entirely or partly encompasses the robot, and for example includes the path around which the robot has a perception of its environment when said robot is needed to move. The possible working volume of the robot is necessarily included in its volume of perception. In order to operate, particularly in collaborative mode, the robot must have a map of its working volume, or its working map. Thus, from the practical point of view, it is desirable to maximize the volume of perception within a given environment.

In a flexible production system, it is frequently necessary to modify the configuration of the environment to reconfigure the factory, and also to move the cobots in that environment or even provide for the collaboration of several cobots for the execution of a given task. Thus, the means for surveying the environment according to the prior art, based on fixed sensors and sensors on board the robot that inform the robot of its concentric working environment, do not provide an overall view of a changing environment. As a result, areas remain, known as shadow areas, where the fixed sensors and the on-board sensors of the robot do not make it possible to understand the environment. These shadow areas reduce the volume of perception of the robot and therefore its useful working volume. The removal of these shadow zones, which are particularly created due to the movement of objects, would make it necessary to modify the position of the fixed sensors and the use of a centralized intelligence system suitable for providing an overall perception of the environment. That task is long and incompatible with the time for changing a production run in an automated flexible production environment, and requires computation means that are out of proportion with the needs of causing the robot to execute production tasks. The problem is even more complex when the robot has a mobile base, and must move in a modified environment in order to change the production configuration.

The document WO 2011 035839 describes an example of a robotic system where several mobile robots communicate with a fixed base that continuously computes a map of the environment on the basis of the information received from said robots. Said base reports the updated map to the different robots, that is provides surplus information in relation to the needs of each robot for carrying out its tasks.

The invention aims to remedy the drawbacks of the prior art and therefore relates to a robot, known as a cobot, particularly with a mobile base, comprising:

a. memory means in which an unvarying map of the space, known as the movement space, in which the cobot is likely to move is saved;

b. sensors on board said cobot that are suitable for informing it about its concentric environment;

c. communication means suitable for issuing and receiving information;

d. computation means suitable for processing the information from the sensors and communication means;

e. means to explore the environment, known as a codrone, separate from the cobot, capable of moving in space on its own and communicating information, obtained by a sensor fitted on said codrone, to the cobot via the communication means.

Thus, the cobot according to the invention has additional means to extend its volume of perception beyond the perception of its on-board sensors and the fixed sensors in the environment. These additional means offer the cobot according to the invention a dynamic image of the environment, from a viewpoint other than the viewpoint acquired by said cobot with its own sensors.

For example, the exploration means can precede the robot in its movements.

The invention can be implemented advantageously in the embodiments described below, which may be considered individually or in any technically operative combination.

In one advantageous embodiment of the cobot according to the invention, the codrone is suitable for flying. Thus, said codrone offers an aerial view of the environment and moves rapidly in an environment that generally contains fewer obstacles than the environment on the floor.

The invention also relates to a robotic system comprising a plurality of cobots according to the invention, wherein said cobots are capable of exchanging data with their means of communication. Thus, the survey of the environment is distributed between the different cobots, which exchange their working maps.

Advantageously, two cobots of the robotic system according to the invention share the same codrone. Thus, the system is made more cost-effective by pooling resources and using exactly the means necessary for surveying the environment.

Advantageously, the robotic system according to the invention comprises means known as planning means, suitable for assigning a work task to a cobot.

The invention also relates to a method for determining the working map of a first cobot in a robotic system according to the invention, which method comprises steps of:

i. surveying the environment of the first cobot via its own on-board sensors;

ii. determining a first working map computed from information from the on-board sensors and the unvarying map saved in the memory means of the first cobot;

iii. determining the shadow areas in said first map;

iv. if such shadow areas exist, communicating with a second cobot to obtain mapping information in the volume of perception of that second cobot;

v. updating the first working map from the information received from the second cobot;

vi. verifying the presence of shadow areas in the second map obtained in that way. Thus the first cobot supplements its working map with information obtained from another cobot. The computation of the working map is distributed and carried out on the scale of each cobot and not in a centralized intelligence system. The computation of the working map is reduced to what is exactly necessary for each cobot, by limiting such computation to the map useful for the tasks of said cobot and not a general map of the space, while taking account of the overall environment, but limiting that consideration to the relevant information.

Advantageously, the working map comprises a navigation grid made up of accessible zones that are superimposed on the unvarying map. This embodiment allows the fluid management of the working map in the memory means of the cobot, as the navigation grid is erased and replaced by another one whenever the cobot changes zones.

Advantageously, step (iv) comprises the steps of:

aiv. Sending a request for mapping information by the first cobot to the other cobots in the movement space, specifying the zones in the navigation grid concerned by the tasks of said first cobot;

biv. if the second cobot is in a zone of the navigation grid through which the first cobot passes, sending to said first cobot the mapping information contained in the volume of perception of the second cobot.

Thus, the mapping information sent is reduced to what is exactly necessary for the needs of the first cobot.

Advantageously, the method according to the invention comprises the steps of:

vii. if any shadow areas remain in the map obtained in step (vi) or if there are shadow areas in step (iii) and step (iv) cannot be carried out;

viii. launching the codrone for surveying the environment;

ix. obtaining information from the codrone by the communication means;

x. updating the working map with the information obtained from the codrone.

Thus, the use of the codrone makes it possible to extend the volume of perception of the cobot, for example when no other cobot is capable of informing said cobot in the area of movement.

Advantageously, the method according to the invention comprises, at the end of step (ii) or step (v) or step (x), a step of:

xi. saving the updated working map in the memory means and using that map for the execution of the tasks of the first cobot.

Thus, the working map saved in the memory means of the cobot is a dynamic map.

Advantageously, when the working environment of the first cobot is modified at the end of step (xi), the method according to the invention comprises the steps of:

xii. erasing the working map of the memory means and returning to the unvarying map;

xiii. determining a new working map by repeating the steps from step (i).

Thus, the working map saved in the memory means of the cobot is reduced to what is strictly necessary.

In a particular embodiment of the method according to the invention where the robotic system comprises planning means, said method comprises tasks consisting in:

xiv. assigning work tasks to the cobot along with a parameter that defines the priority of execution of said tasks;
the request of step (aiv) comprising the sending of the priority parameter corresponding to the task of said first cobot.

Thus, the cobots in the system coordinate their information and their movements according to a hierarchy defined by the nature of the tasks to execute.

In an exemplary implementation of this particular embodiment, a second cobot assigned to a task with lower priority than the first cobot acts as an obstacle for the work task of the first cobot and the method comprises a step of:

xv. moving the second cobot in order to clear the working space of the first cobot.

In another exemplary implementation of this particular embodiment, the priority work task of the first cobot comprises movement in the movement space of the codrone that precedes the first cobot in its movement. Thus, the codrone informs the cobot of any obstacle in its path and any change in the configuration of the working map.

Advantageously, the codrone (190) comprises means suitable for sending a warning signal and said codrone that precedes the first cobot (100) in its movement sends said warning signal. Thus, the operators, particularly human operators, present in the vicinity of the path of the cobot are alerted of the imminence of its passage.

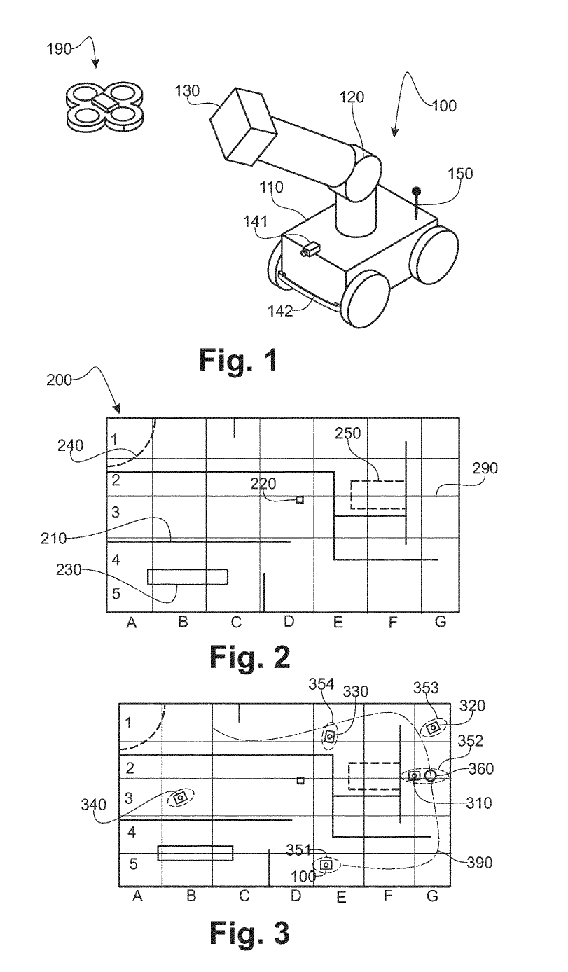

The invention is described below in its preferred embodiments, which are not limitative in any way, and by reference to FIGS. 1 to 5, wherein:

FIG. 1 is a schematic perspective view of an exemplary embodiment of a cobot according to the invention;

FIG. 2 is a schematic top view of an exemplary unvarying map saved in the memory means of the cobot according to the invention;

FIG. 3 is a top view of an exemplary robotic system according to the invention, moving in the space corresponding to the unvarying map of FIG. 2;

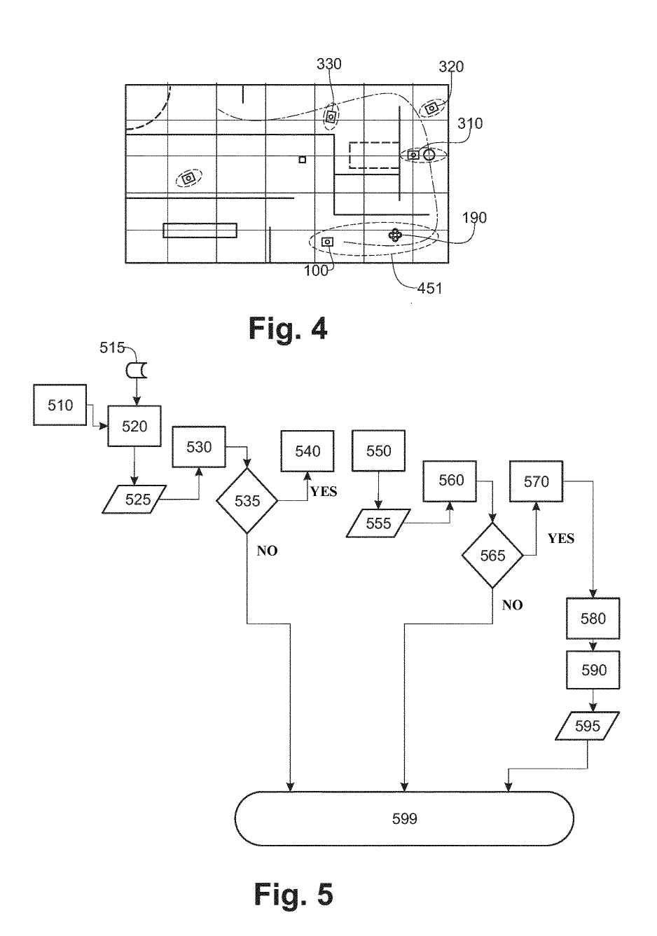

FIG. 4 is a top view of an exemplary embodiment of a robotic system according to the invention comprising a codrone; and

FIG. 5 is a logical diagram of an exemplary embodiment of the method according to the invention.

In FIG. 1 of an exemplary embodiment of the cobot (100) according to the invention, said cobot comprises a mobile base (110) for the movement of the cobot in an environment known as the movement space. Said mobile base supports an assembly (120) of motorized axes, for example a manipulating arm, which assembly of axes is used to move an effector (130) during the work tasks of said cobot. In non-limitative examples, said effector (130) consists in a welding, riveting, machining, measuring, handling, grasping and manipulation or painting device or a combination of said devices. Said cobot (100) comprises means (141, 142) for surveying its concentric environment, for example one or more video cameras (141) associated with an image processing system, or a three-dimensional laser scanning system (not shown) or a contact sensor (142) or bumper, in a non-limitative manner. The cobot according to the invention comprises communication means (150), for example radio means according to the Wi-Fi® protocol, enabling it to exchange data with other cobots. Finally, the cobot (100) according to the invention comprises environment exploration means (190), for example a drone of the quadcopter type, capable of moving on its own in the environment and connected to the cobot (100) by communication means (150). Said exploration means or codrone (190) comprises sensors suitable for perceiving the environment, such as one or more video cameras, a radar, a three-dimensional laser scanning device, and means for geolocating said codrone (190) in space. In this exemplary embodiment, the mobile base (110) comprises memory means and computation means (not shown). The exploration means are not limited to a flying drone and are adapted to the environment to survey. Said exploration means are advantageously made up of a robotic vehicle with greater movement agility or abilities to perceive the environment than those of the cobot. Those exploration means are not assigned to tasks other than exploration. In alternative embodiments, the codrone comprises its own movement intelligence, which makes it suitable for moving independently in the environment, or that movement intelligence is shared between the codrone and the cobot.

In FIG. 2 of a schematic exemplary embodiment, the memory means of the cobot according to the invention comprise a record of the unvarying map (200) of the space in which said cobot is likely to move. That map (200) comprises the coordinates, in a definite system of axes, of fixed elements in the movement space of the cobot, for example walls (210) or partitions, pillars (220) or trenches (230) or basins that cannot be crossed. In an exemplary embodiment, the unvarying map also comprises the identification of zones (240) in which the cobot cannot move because the conditions prevalent in those zones, such as temperature, radiations, sterility requirements etc. on a non-limitative basis do not allow it to go there, that is to say forbidden zones. In another exemplary embodiment, compatible with the previous ones, the unvarying map also comprises the identification of zones (250) that cannot be explored by the codrone.

In an exemplary embodiment, the map comprises a grid (290) known as the navigation grid. In this exemplary embodiment, said grid divides the movement space into squares, which are identified by a combination of a letter (A, B, E, D, E, F, G) and a number (1, 2, 3, 4, 5) and identified individually in a system of axes of the map of the cobot. Advantageously, the dimensions of the squares are suited to the volume of perception of the cobot.

Other than fixed unvarying elements, the mapped movement space also comprises fixed elements, the position of which is likely to be modified, such as tables or cabinets (not shown) and mobile elements, such as other cobots, human operators or handling devices such as lift trucks. Not only are the mobile elements and fixed variable elements liable to change positions in the movement space, but they are also liable to move in and out of it. Thus, these elements are not part of the unvarying map.

In FIG. 3 of an exemplary embodiment, the robotic system according to the invention comprises a plurality of cobots (100, 310, 320, 330, 340). Said robotic system advantageously comprises a positioning system shared by all the cobots (100, 310, 320, 330), which are also synchronized in time. For example, these functions are provided by a satellite geolocation system, fixed markers, radio computer network means such as Wi-Fi® or any other system. The geolocation function over the entire working space is not necessary. Insofar as the cobots present in the space share information from their on-board sensors, it is sufficient to determine the position of each cobot with which another cobot shares information in the unvarying map. That position can be determined by the proximity of said cobot in relation to definite points on the map. Each cobot has a volume (351, 352, 353, 354) of perception that corresponds to the perception of the cobot of its environment. In a first exemplary embodiment of the method according to the invention, one (100) of these cobots is required to move along a path (390) in that environment and so uses both information from the unvarying map in the memory and the information collected by the other cobots (310, 320, 330) to compute its working map corresponding to the covering of said path (390). Thus, said cobot (100) extends its volume of perception to all the volumes of perception of the cobots (310, 320, 330) present in its movement space that are concerned by the path (390). For example, that allows said cobot (100) to detect the presence of an obstacle (360) on its initially planned path (390) even when that obstacle is not visible in its own volume (351) of perception, but said obstacle is visible to one (310) of the other cobots. This embodiment is not limited to the case of the movement of the cobot (100) in the working space, but also applies to the case of cooperation between two fixed cobots, which are close to each other and carry out work tasks that may or may not be complementary. Thus, before making the movement corresponding to a given path (390), the first cobot (100) sends a request to all the other cobots and specifies, in this exemplary embodiment, the squares on the navigation grid that will be crossed, that is E5, F5, G5, G4, G3, G2, G1, F1, E1, D1, C1 in this exemplary embodiment. Upon the receipt of the request, the cobots (330, 320) placed in one of the relevant squares and the cobots (310) whose volume (352) of perception covers any part of one of the squares concerned by the path share mapping information with the first cobot (100), which updates its working map in the relevant squares if necessary. On the other hand, the cobots (340) located outside the concerned squares do not respond to the request and do not share information with the first cobot. Thus, data exchange is reduced, and only the relevant squares of the map are updated. In this exemplary embodiment, at the end of the querying of the other cobots, shadow areas remain in the working map of the first cobot, that is to say, in this exemplary embodiment, the squares (F5, G5, G4, F1, D1, C1) that are located on the intended path but are perceived neither by the first cobot (100) itself nor by any of the other cobots.

In FIG. 4 of an exemplary embodiment of the robotic system according to the invention, in order to extend its volume (451) of perception so as to cover the shadow areas, one of the cobots (100) launches the codrone (190) associated with it and receives the environment perception information sent by that codrone (190). In an alternative embodiment, said codrone (190) is shared between several cobots (310, 320, 330) present in the working space. In an exemplary embodiment, the use of the codrone shared in this way by any of the cobots is defined by a parameter that assigns a priority index to each task carried out by each cobot. The codrone (190) advantageously comprises means to define its location in said movement space, either by sharing the geolocation means of the cobots, or by means allowing it to be located in relation to one of the cobots.

In an exemplary embodiment, when the first cobot (100) starts on its path (390), it queries the other cobots regularly, for example every 10 ms or every second, depending on the movement speed and the nature of the environment. Such querying is firstly limited to the zones or squares to cross, and does not relate to squares that have already been crossed. In an even more advantageous embodiment, the first cobot (100) computes the foreseeable duration of its journey based on the path corrected in the working map updated on the basis of the first query. Then, said first cobot (100) only sends queries limited to the squares crossed by said cobot (100) within the period corresponding to the next query, which further limits the quantity of data exchanged. In order to make said first cobot move even faster, for example when it is assigned to a priority task, the codrone precedes the cobot in its movement and thus allows said cobot to anticipate any obstacle in its path. Advantageously, the codrone comprises means (not shown) for sending a warning signal. As a non-limitative example, said means consist in a warning sound, a warning light or means to send a radio signal or a specific code on the network connecting the cobots and the drone or a combination of those means. Thus, during its movement preceding the cobot, said drone emits an appropriate signal to warn the cobots or the operators located near the path of the cobot (100) preceded by it of the imminent irruption of the cobot in their environment.

In FIG. 5 of an exemplary embodiment of the method according to the invention, to determine its working map, the cobot according to the invention analyses its environment with its on-board sensors such as a video camera and three-dimensional laser scanning device during a concentric survey step (510). Using the information received, the computation means of the cobot determine, during a map computation step (520), a first working map by superimposing the information obtained during the concentric survey step (510) on the unvarying map (515) saved in the memory means. Said first working map is saved (525) in the memory means. That first map is analyzed during an analysis step (530), in order to determine whether said working map includes shadow areas. That analysis is achieved by comparing the volume of perception corresponding to the computed map with the movement of the cobot in space, that is to say its movement by means of the mobile base or the movement of its effector by means of the motorized axis system; these movements correspond to those required for the execution of the task assigned to said cobot. If the volume of the movement is entirely contained within the volume of perception, then there is no shadow area. Otherwise, a shadow area exists where the working volume is not within the volume of perception. Thus, during a test step (535), the presence of shadow areas is analyzed. If there is a shadow area, the cobot uses its communication means to send (540) a request to the other cobots present in the working space in order to collect mapping data to supplement the working map in said shadow areas. Using the collected data, the working map is recomputed during an update step (550) and saved (555) in the memory means. That new map is analyzed during an analysis step (560) in order to detect any remaining shadow areas. During a test step (565), if the presence of shadow areas is detected in said new working map, then the codrone is used to survey the environment additionally during a launch step (570). The mapping data sent by the codrone are collected (580) by the cobot and are used to update (590) the working map that is saved (595) in the memory means. The working map without any shadow areas saved (525, 555, 595) in the memory means is used (599) by the cobot to carry out its work tasks. If the cobot is once again moved in the working environment, or if the working environment is modified, said map is erased and thus reverts to the unvarying map and the survey step is, in this exemplary embodiment, repeated from the concentric survey step (510). This exemplary embodiment follows the process for updating the working map on the scale of the same cobot. From a practical viewpoint, when a cobot turns to another cobot to extend its volume of perception, it is likely that the cobot sending that request is liable to enter, during its work task or during its movement, the working map of the cobot receiving the request. Thus, a similar process is advantageously engaged by the queried robot to update its own working map. In the robotic system according to the invention, the cobots thus regularly exchange information about their environment to the extent necessary, so that the working maps of said cobots are updated whenever their environment is modified, and that update only concerns the relevant modified zone.

Thus, like the work of several human operators on a job, job steering that uses the robotic system according to the invention limits the intervention of a centralized intelligence system to the definition and planning of the work tasks of the cobots; said cobots themselves carry out the auxiliary functions of those tasks such as movements from one working area to another. Thus, in an exemplary embodiment, the robotic system according to the invention comprises planning means (not shown), which may for example consist in a computer connected to the cobots in the system by a wireless network. Said planning means are capable of working independently using given algorithms and an intervention diagram, or are programmed by a supervising operator.

Said planning means comprise a list of tasks to be carried out by each of the cobots in the robotic system, a hierarchy of said tasks, the spatial location of said tasks in the movement space and the time slot for the performance of each task. Said list is regularly updated.

Thus, the supervisor who has to manage the joint activity of several cobots in the movement space merely assigns tasks to those cobots and the cobots themselves manage their movements in that space depending on the priorities. The description above and the exemplary embodiments show that the invention achieves the objectives sought, in particular, it makes it possible to pool the perception of the environment by a robotic system and also to pool between cobots the means for computing the map and thus obtain a dynamic working map for each cobot. The use of a codrone, possibly shared by several cobots, makes it possible to rapidly and independently cover all the shadow areas. Thus, the robotic system is flexible and capable of readapting to a changing production environment without any reprogramming intervention. The system according to the invention is particularly suited to large factories organized for flexible production, particularly in the building of ships and aircraft.

1-15. (canceled)

16. A cobot with a mobile base, comprising:
a memory to store an unvarying map of a space in which the cobot is likely to move;
sensors on board the cobot, the sensors are configured to inform the cobot about its concentric environment;
a transmitter/receiver to issue and receive information;
a processor configured to process the information from the sensors and the transmitter/receiver; and
a codrone, separate from the cobot, to explore the environment and configured to move in the space independently from the cobot and to communicate information to the cobot via the transmitter/receiver.

17. The cobot according to claim 16, wherein the codrone is configured to fly.

18. A robotic system comprising a plurality of cobots according to claim 16, wherein the cobots are configured to exchange data with each other via their transmitters/receivers.

19. The robotic system according to claim 18, wherein two cobots share a same codrone.

20. The robotic system according to claim 18, further comprising a task planner configured to assign a work task to a cobot.

21. A method for determining a working map of a first cobot in the robotic system according to claim 18, comprising the steps of:
surveying the environment of the first cobot via the on-board sensors of the first cobot;
determining a first working map computed from the information about the environment surveyed by the on-board sensors and the unvarying map stored in the memory of the first cobot;
determining shadow areas in the first working map;
communicating with a second cobot to obtain mapping information in a volume of perception of the second cobot in response to a determination that the shadow areas exist in the first working map;
updating the first working map from the mapping information received from the second cobot to provide the working map; and
verifying a presence of the shadow areas in the working map.

22. The method according to claim 21, wherein the working map comprises a navigation grid comprising accessible zones that are superimposed on the unvarying map.

23. The method according to claim 22, wherein the step of communicating further comprises steps of:
transmitting a request for the mapping information by the first cobot to other cobots in a movement space, specifying the zones in the navigation grid for performing work tasks of the first cobot; and
transmitting to the first cobot by another cobot in a zone of the navigation grid through which the first cobot passes, the mapping information obtained in the volume of perception of said other cobot.

24. The method according to claim 21, in response to a determination that either the shadow areas remain in the working map or the first cobot is unable to communicate with the second cobot to obtain the mapping information, the method further comprises steps of:
launching the codrone to surveying the environment;
obtaining the information from the codrone by the transmitter/receiver; and
updating the working map with the information obtained from the codrone.

25. The method according to claim 24, further comprising steps of saving the updated working map in the memory and utilizing the updated working map to execute working tasks of the first cobot.

26. The method according to claim 25, further comprising a step of modifying a working environment of the first cobot after saving the updated working map by: erasing the updated working map from the memory, returning to the unvarying map, and determining a new working map by repeating the previous steps.

27. The method according to claim 23, further comprising steps of assigning a work task to the first cobot along with a priority parameter that defines a priority of execution of the work task; and transmitting the priority parameter with the request for the mapping information by the first cobot.

28. The method according to claim 27, further comprising a step of moving the second cobot to clear a working space of the first cobot in response to a determination that the second cobot assigned to a work task with a lower priority than the first cobot is an obstacle to the first cobot executing its work task.

29. The method according to claim 28, wherein the work task of the first cobot comprises a movement in the movement space and the codrone precedes the first cobot in its movement.

30. The method according to claim 29, further comprising the step of transmitting a warning signal by the codrone that precedes the first cobot in its movement.
